(19) United States
(12) Patent Application Publication
(10) Pub. No.: US 2026/0023659 A1
(43) Pub. Date: Jan. 22, 2026

(54) BACKUP DATA MIGRATION

(71) Applicant: Kyndryl, Inc., New York, NY (US)

(72) Inventors: Chris Bode, Holly Springs, NC (US); Daniela Mainieri, Porto Alegre (BR); MIKAEL LINDSTROM, Sollentuna (SE)

(21) Appl. No.: 18/775,496

(22) Filed: Jul. 17, 2024

(51) Int. Cl. G06F 11/14

(52) U.S. Cl. CPC G06F 11/1469; G06F 2201/84

(57) ABSTRACT

Embodiments build an inventory of existing backups in a legacy system, initiate a restore for the existing backups in the legacy system, intercept a plurality of operations of the legacy system, send data which comprises a specific marker pattern in response to intercepting the plurality of operations, and build a storage map using the data which comprises the specific marker pattern.

### MIGRATIONBACKGROUND

Aspects of the present invention relate generally to backup data migration and, more particularly, to systems and methods for backup data migration without restore based migration.

Data is typically backed up to storage in at least one propriety format. In an example of data backup, deduplication results in a single segment of data on a storage device which corresponds with multiple backups taken across multiple days from multiple clients.

### SUMMARY

In a first aspect of the invention, there is a computer-implemented method including: building, by a computing device, an inventory of existing backups in a legacy system; initiating, by the computing device, a restore for the existing backups in the legacy system; intercepting, by the computing device, a plurality of operations of the legacy system; sending, by the computing device, data which includes a specific marker pattern in response to intercepting the plurality of operations; and building, by the computing device, a storage map using the data which includes the specific marker pattern.

In another aspect of the invention, there is a computer program product including one or more computer readable storage media having program instructions collectively stored on the one or more computer readable storage media. The program instructions are executable to: receive a storage map which includes a specific marker pattern and information regarding data to be backed up; build at least one virtual filesystem based on the received storage map; exposing the at least one virtual filesystem to the data to be backed up; and initiate a backup of the data to be backed up in response to exposing the at least one virtual filesystem to the data to be backedup.

In another aspect of the invention, there is a system including a processor, a computer readable memory, one or more computer readable storage media, and program instructions collectively stored on the one or more computer readable storage media. The program instructions are executable to: build an inventory of existing backups in a legacy system; initiate a restore for the existing backups in the legacy system; intercept a plurality of operations of the legacy system; send data which includes a specific marker pattern in response to interception of the plurality of operations; build a storage map using the data which includes the specific marker pattern; and provide a backup of data corresponding to the built storage map.

In another aspect of the invention, there is a computer-implemented method including: building, by a computing device, an inventory of existing backups in a legacy system; initiating, by the computing device, a restore for the existing backups in the legacy system; intercepting, by the computing device, a plurality of operations of the legacy system; sending, by the computing device, data which includes a specific marker pattern in response to intercepting the plurality of operations; building, by the computing device, a storage map using the data which includes the specific marker pattern; building, by the computing device, at least one virtual filesystem based on the built storage map; exposing, by the computing device, the at least one virtual filesystem to the data to be backed up; and initiating, by the computing device, a backup of the data to be backed up in response to exposing the at least one virtual filesystem to the data to be backed up.

In another aspect of the invention, there is a computer program product including one or more computer readable storage media having program instructions collectively stored on the one or more computer readable storage media. The program instructions are executable to: build an inventory of existing backups in a legacy system; initiate a restore for the existing backups in the legacy system; intercept a plurality of operations of the legacy system; send mimicked restore data which includes a specific marker pattern in response to interception of the plurality of operations; build a storage map using the mimicked restore data which includes the specific marker pattern; build at least one virtual filesystem based on the built storage map; expose the at least one virtual filesystem to the data to be backed up; and initiate a backup of the data to be backed up in response to exposing the at least one virtual filesystem to the data to be backed up. The specific marker pattern comprises embedded patterns to mark data locations and is used to determine offsets within individual files being restored.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the presentinvention.

FIG. 2 depicts a cloud computing environment according to an embodiment of the present invention.

FIG. 3 depicts abstraction model layers according to an embodiment of the presentinvention.

FIG. 4 shows a block diagram of a backup data migration system in accordance with aspects of the present invention.

FIG. 5 shows another block diagram of the backup data migration system in accordance with aspects of the present invention.

FIG. 6 shows a flowchart of the backup data migration system in accordance with aspects of the present invention.

FIG. 7 shows another flowchart of the backup data migration system in accordance with aspects of the present invention.

FIG. 8 shows another flowchart of the backup data migration system in accordance with aspects of the present invention.

FIG. 9 shows another block diagram of the backup data migration system in accordance with aspects of the present invention.

FIG. 10 shows another block diagram of the backup data migration system in accordance with aspects of the present invention.

### DETAILED DESCRIPTION

Aspects of the present invention relate generally to backup data migration and, more particularly, to systems and methods for backup data migration without restore based migration. Aspects of the present invention may be implemented as a system, method, or computer program product. The system, method, or computer program product builds a map of existing data on disk enabling clients to shed the cost of existing backup software without having to physically migrate all of the existing data. In addition, the system, method, or computer program product bypasses a need to integrate with a legacy backup client to move data into a new backup system. The system, method, or computer program product also exposes the data via a virtual filesystem that is used to access the data or migrate the data based on a customer request. The systems and methods provided herein may be computer implemented methods.

More specifically, the system, method, or computer program product described herein provides an input/output filter driver which embeds patterns to mark data locations. The system, method, or computer program product also uses the input/output filter driver in conjunction with false returns containing the embedded patterns to mark the data locations. Further, the system, method, or computer program product reduces a burden of migrating between backup software vendors such that the new backup software restores the old backup data without utilizing restore based migration methods. Embodiments also provide for bolt on technology which does not require any knowledge of backup software used in legacy system or proprietary software. As should be understood by those of ordinary skill in the art, bolt-on refers to a technology solution or system that is added to an existing infrastructure without major modifications or integrations to improve currently known processes, functionality and/or features.

The system, method, or computer program product reduces the cost and complexity of migrating between backup software vendors. In this way, it is possible to avoid a need for physical data transfer between systems in order to make legacy data backups restorable. Further, the system, method, or computer program product avoids significant labor costs involved in providing ongoing support and licensing costs for legacy software which is no longer in activeuse.

In addition, embodiments of the present invention mimic restore requests for long term retention backups using a native command line interface (CLI) and/or application programming interface (API) of the source backup application. Accordingly, implementations of the present invention intercepts read requests created by a backup software and inserts memory generated responses. Further, embodiments of the present invention analyze the data stream in response to the mimicked restore for placed markers in the generated responses to determine offsets within the files being restored. Aspects of the present invention simultaneously record the objects and/or disk blocks read by the backup application. In further embodiments, this process is repeated for all relevant restore points to build a map of the exact storage locations for all backup data being migrated. Implementations of the present invention present the data to the new backup application using the mapped storage locations for all backup contents. In further aspects of the present invention, the data is extended by recovering the data and sending the data to a new backup application if a client desires to retire the legacy infrastructure and legacy software.

In contrast, known systems simply write backup data to storage in proprietary formats. Accordingly, known systems and methods increase complexity when using deduplication for providing data restores. Further, known systems and methods do not provide any way to reduce licensing and support costs when writing backup data to storage in proprietary formats because customers typically have to retain legacy systems and software due to legal and regulatory requirement which require maintenance of data for a long period of time (e.g., many months or years). In contrast, the systems, methods, and computer program products as described herein make improvements on the known systems by reducing the licensing and support costs for legacy systems and software by avoiding a need for physical data transfer between systems and also having flexibility to backup data that is in proprietary formats without costly software and/ortools.

Accordingly, implementations of the present invention provide a technical feature (e.g., technical solution) to a technical problem and a practical application of data backup, which is deeply rooted in computer technology. For example, the steps and/or processes presented are computer-based and cannot be performed in the human mind, in addition to providing technical features in the practical application. These steps and/or processes include, for example, building, by a computing device, an inventory of existing backups in a legacy system; initiating, by the computing device, a restore for the existing backups in the legacy system; intercepting, by the computing device, a plurality of operations of the legacy system; sending, by the computing device, data which comprises a specific marker pattern in response to interception the plurality of operations; and building, by the computing device, a storage map using the data which comprises the specific marker pattern. For example, these steps including the initiating, intercepting and building, a storage map, by definition, is performed by a computer and cannot practically be performed in the human mind (or with pen and paper) due to the complexity and massive amounts of calculations involved. Given the scale and complexity of initiating a restore for existing backups, intercepting a plurality of operations, and building a storage map using data which comprises a specific marker patter, it is simply not possible for the human mind, or for a person using pen and paper, to perform the number of calculations involved in real-time, amongst other features described herein, without being rooted in computer technology.

It should be understood that, to the extent implementations of the invention collect, store, or employ personal information provided by, or obtained from, individuals (for example, users associated with service tickets), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable programinstructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computerinstructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or laterdeveloped.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environmentconfigurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

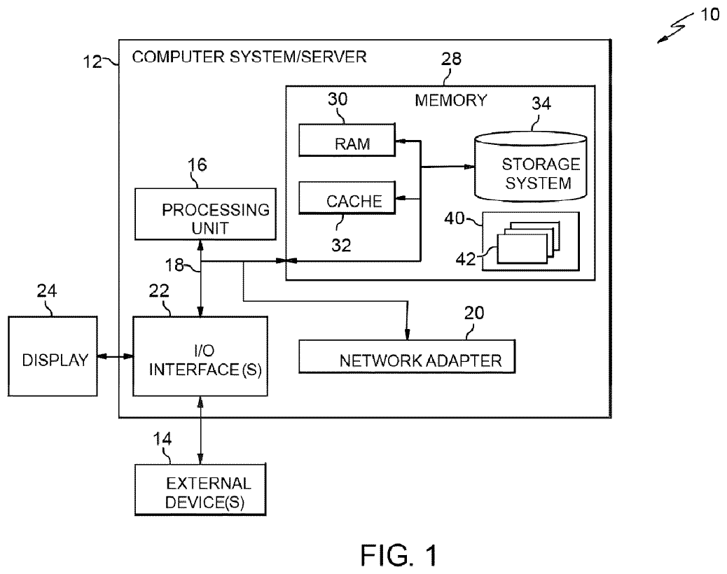

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storagedevices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems,etc.

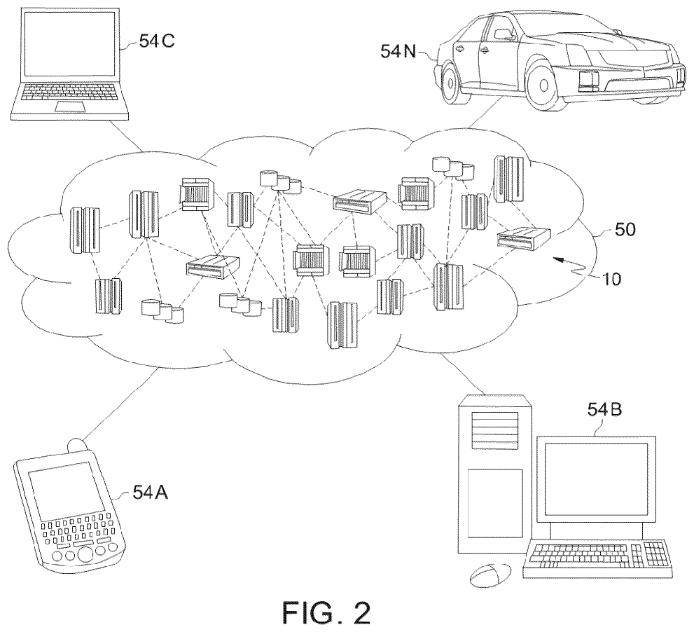

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

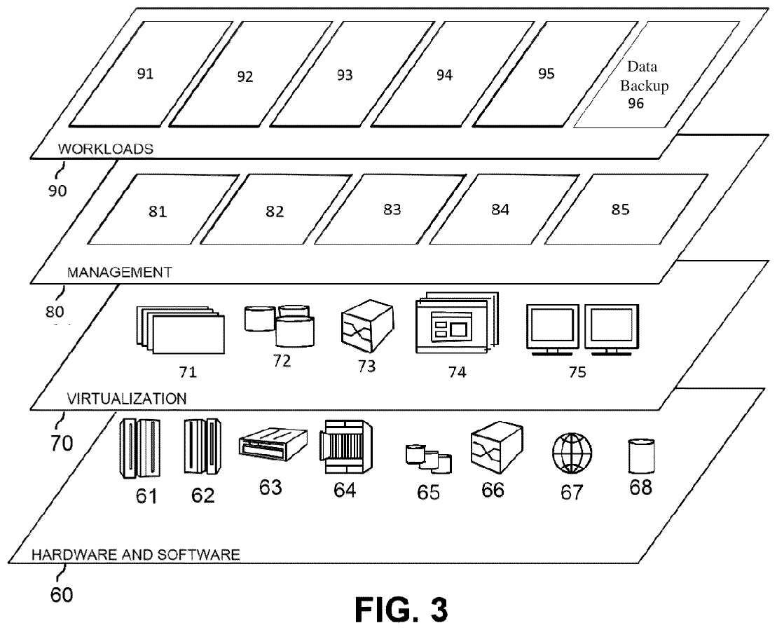

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data backup 96.

Implementations of the invention may include a computer system/server 12 of FIG. 1 in which one or more of the program modules 42 are configured to perform (or cause the computer system/server 12 to perform) one of more functions of the data backup 96 of FIG. 3. For example, the one or more of the program modules 42 of the data backup 96 may be configured to: build an inventory of existing backups in a legacy system; initiate a restore for each of the existing backups in the legacy system; intercept a plurality of operations of the legacy system; send data which comprises a specific marker pattern in response to intercepting the plurality of operations; and build a storage map using the data which comprises the specific marker pattern. In this way, it is now possible to backup data without having to physically migrate or store the existing data in legacy systems.

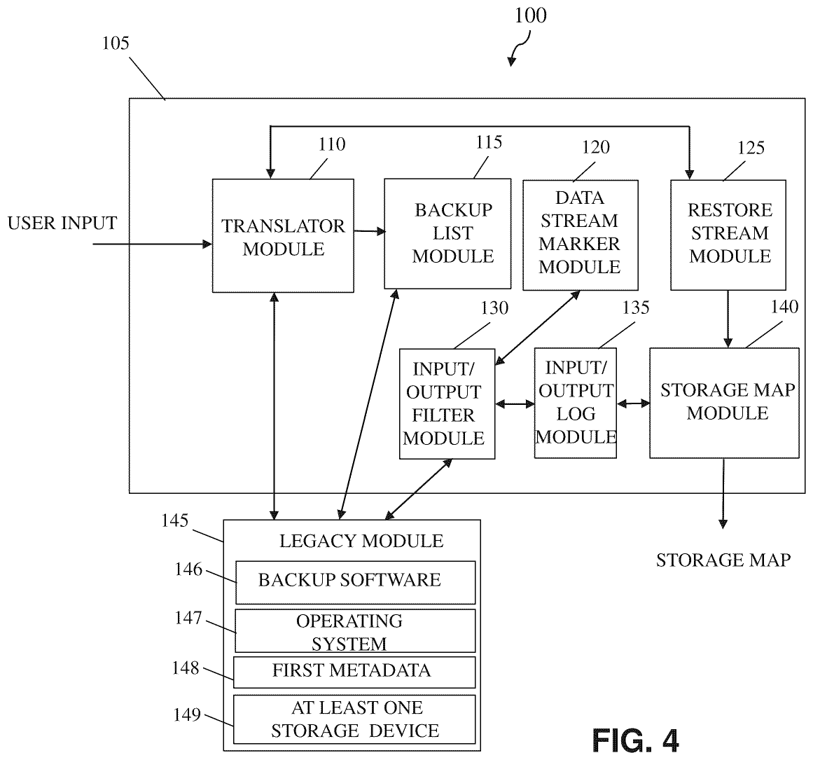

FIG. 4 shows a block diagram of a backup data migration system 100 in accordance with aspects of the invention. In embodiments, the backup data migration system 100 comprises a backup data environment 105. The backup data environment 105 includes a translator module 110, a backup list module 115, a data stream marker module 120, a restore stream module 125, an input/output (I/O) filter module 130, an input/output (I/O) log module 135, and a storage map module 140, each of which may comprise one or more program modules such as program modules 42 described with respect to FIG. 1 and the data backup 96 shown in FIG. 3. Further, in FIG. 4, a legacy module 145 may be external to the backup data migration system 100. In aspects of the present invention, the legacy module 145 may include backup software 146, an operating system (OS) 147, first metadata 148, and at least one storage device 149 (e.g., tape storage, object storage, and disk storage). In another embodiment of the present invention, the I/O filter module 130 may be included in the OS 147 of the legacy module 145.

The backup data migration system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the translator module 110 receives a user input, such as a source client, retention policy, etc., and sends the user input to the backup list module 115. In further embodiments, the translator module 110 communicates with the backup software 146 of the legacy module 145 for building up an inventory of existing backups in the legacy module 145. In aspects of the present invention, the inventory of the existing backups is pruned based on the received user input. In an example, the inventory of the existing backups may be pruned by only including data from a specific client. In further embodiments, the translator module 110 sends the inventory of existing backups from the legacy module 145 to the backup list module 115.

In FIG. 4, the backup list module 115 receives the user input and the inventory of existing backups from the translator module 110 and initiates a restore operation for each backup. During the restore operation, as the backup software 146 of the legacy module 145 attempts to read data from the at least one storage device 149 of the legacy module 145, the input/output (I/O) filter module 130 communicates with the legacy module 145 and intercepts input/output (I/O) operations between the backup software 146 of the legacy module 145 and the at least one storage device 149 or object storage network operations between the backup software 146 of the legacy module 145 and the at least one storage device 149. The I/O filter module 130 also logs which blocks and/or objects were read or attempted to be read by the backup software 146 of the legacy module 145 and sends which blocks and/or objects were read or attempted to be read by the backup software 146 to the data stream marker module 120.

In FIG. 4, the data stream marker module 120 sends a specific marker pattern to the I/O filter module 130 in response to receiving which blocks and/or objects were read or attempted to be read by the backup software 146. In embodiments, the specific marker pattern comprises embedded patterns to mark data locations. In further embodiments, the embedded patterns include the data locations to determine a plurality of offsets within individual files being restored. In particular, the specific marker pattern is used to determine the plurality of offsets within individual files of the data being restored. The I/O filter module 130 intercepts requests from the backup software 146 of the legacy module 145 to at least one storage device and responds to the requests from the backup software 146 with data which includes the specific marker pattern. In embodiments, the specific marker pattern corresponds with the data that is trying to be read from the backup software 146. The backup software 146 of the legacy module 145 sends the data with the specific marker pattern to the translator module 110. The I/O filter module 130 also determines what address on the at least one storage the backup software 146 of the legacy module 145 was trying to read and sends the address of the at least one storage the backup software 146 was trying to read to the I/O log module 135.

In aspects of the present invention in FIG. 4, the translator module 110 sends the data with the specific marker pattern to the restore stream module 125. The restore stream module 125 identifies the specific marker pattern in the data with the specific marker pattern based on a mapping of the specific marker pattern to a plurality of offsets within the files being restored. The restore stream module 125 then sends the data with the specific marker pattern and the specific marker pattern to the storage map module 140.

In embodiments of FIG. 4, the storage map module 140 receives the data with the specific marker pattern and the specific marker pattern from the restore stream module 125. The storage map module 140 also receives, from the I/O log module 135, the address of the at least one storage device 149 the backup software 146 was trying to read. The storage map module 140 builds a storage map using the specific marker pattern, the data with the specific marker pattern, and the address of the at least one storage device 149. The built storage map from the storage map module 140 charts and maps exactly where each piece of data is located on the at least one storage device 149. In particular, the storage map includes details on where portions of individual objects or disk blocks are located on the at least one storage device 149. The storage map module 140 may output the storage map to an external system (as shown in FIG. 4). Alternatively, the storage map module 140 may store the storage map within the backup data environment 105.

Aspects of the present invention in FIG. 4 mimic restore requests for long term retention backups using the native command line interface (CLI) and/or the application programming interface (API) of the translator module 110. Accordingly, implementations of the present invention uses the I/O filter module 130 to intercept read requests created by the backup software 146 and inserts memory generated responses. Further, embodiments of the present invention utilizes the restore stream module 125 to analyze the data stream in response to the mimicked restore for placed markers in the generated responses to determine offsets within the files being restored. Aspects of the present invention simultaneously records the objects and/or disk blocks read by the backup software 146. In further embodiments, this process is repeated for all relevant restore points such that the storage map module 140 builds the storage map of the exact storage locations for all backup data being migrated. Implementations of the present invention present the data to the new backup software 162 using the mapped storage locations (i.e., the build storage map) for all backup contents. In further aspects of the present invention, the data is extended by recovering the data and sending the data to the new backup software 162 in response to a client requesting retirement of the legacy infrastructure and legacy software (i.e., the legacy module 145).

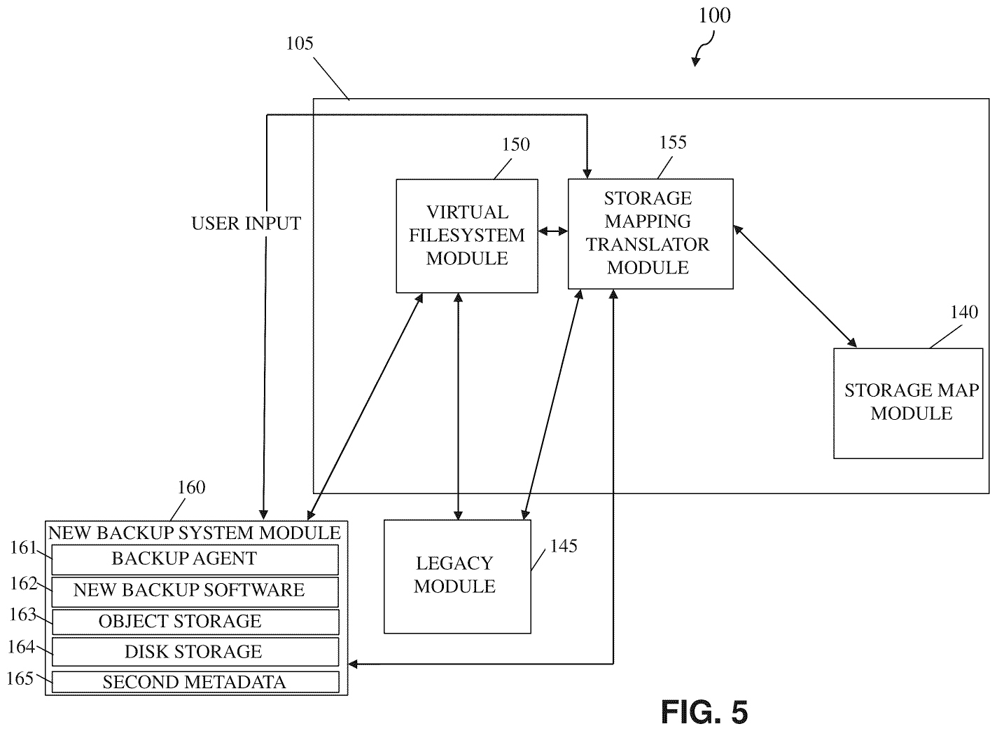

FIG. 5 shows another block diagram of the backup data migration system in accordance with aspects of the present invention. In this embodiment, the backup data environment 105 includes the storage map module 140, a virtual filesystem module 150, and a storage mapping translator module 155, each of which may comprise one or more program modules such as program modules 42 described with respect to FIG. 1 and the data backup 96 as shown in FIG. 3. Further, in FIG. 5, a legacy module 145 and a new backup system module 160 may be external to the backup data migration system 100. In aspects of the present invention, the legacy module 145 may include the backup software 146, the operating system (OS) 147, first metadata 148, and the at least one storage device 149 (e.g., tape storage, object storage, and disk storage) as described in FIG. 4. In another embodiment of the present invention, the I/O filter module 130 may be included in the OS 147 of the legacy module 145. In further aspects of the present invention, the new backup system module 160 may include a backup agent 161, a new backup software 162, an object storage 163, a disk storage 164, and second metadata 165.

The backup data migration system 100 may include additional or fewer modules than those shown in FIG. 5. In embodiments, separate modules may be integrated into a single module. Additionally, or alternatively, a single module may be implemented as multiple modules. Moreover, the quantity of devices and/or networks in the environment is not limited to what is shown in FIG. 5. In practice, the environment may include additional devices and/or networks; fewer devices and/or networks; different devices and/or networks; or differently arranged devices and/or networks than illustrated in FIG. 5. For example, the backup data migration system 100 comprising the backup data environment 105 in FIG. 5 may also include the modules shown in FIG. 4. The backup data environment 105 in FIG. 5 does not show the modules in FIG. 4 for ease of description and to emphasize the operations with regards to the storage map module 140, the virtual filesystem module 150, and the storage mapping translator module 155.

In embodiments of FIG. 5, the storage mapping translator module 155 reads the specific marker pattern, the data with the specific marker pattern, and the address of the at least one storage device 149 which the backup software 146 was trying to read from the storage map of the storage map module 140 to identify where each available objected is located within the at least one storage device 149. The storage mapping translator module 155 locates the data from the at least one storage device 149 in the legacy module 145 using pointers included in the storage map. The storage mapping translator module 155 builds at least one virtual filesystem and sends the at least one virtual filesystem to the virtual filesystem module 150. In this way, data from the at least one storage device 149 in the legacy module 145 is exposed through the at least one virtual filesystem in the virtual filesystem module 150.

In further embodiments of FIG. 5, the backup agent 161 for the new backup system module 160 is installed in a server which is exposed to the at least one virtual filesystem in the virtual filesystem module 150. The backup agent 161 for the new backup system module 160 receives another user input which includes a list of virtual filesystems to backup. In this way, the backup agent 161 of the new backup system module 160 initiates a backup in response to receiving the other user input which includes the list of virtual filesystems to backup. In particular, the backup agent 161 of the new backup system module 160 communicates with the virtual filesystem module 150 to backup the list of virtual filesystems in the virtual filesystem module 150. The virtual filesystem module 150 sends the backup of the list of virtual filesystems to the new backup software 162 in the new backup system module 160.

In aspects of the present invention, the object storage 165 of the new backup system module 160 reads the data of the backup from the new backup software 162 and writes the data of the backup from the new backup software 162 to the disk storage 164 of the new backup system module 160. In embodiments, the storage mapping translator module 155 marks the data of the backup as already restored and “ready to be expired” in response to the backup of the virtual filesystems in the virtual filesystem module 150 being completed. In further embodiments, a user can send another user input to the storage mapping translator module 155 which initiates deletion of data marked as “ready to be expired”. The data that is marked as “ready to be expired” is deleted from the legacy module 145. Implementations of the present invention also may decommission the legacy module 145 and the backup data environment 105 in FIG. 5 in response to the data from the legacy module 145 being backed up to the new backup system module 160.

Accordingly, the backup data environment 105 creates a set of virtual filesystems in the virtual filesystem module 150. In embodiments, the virtual filesystem module 150 may utilize one virtual filesystem per restore point in the legacy module 145. Further, the backup data environment 105 presents the restore point to the new backup system module 160. In further embodiments, the backup data environment 105 automates backup jobs in the new backup system module 160, which are pointed at the set of virtual filesystems in the virtual filesystem module 150. Also, in aspects of the present invention, the virtual filesystem module 150 fetches data from the at least one storage device 149 in the legacy module 145 according to the storage map of the storage map module 140 in response to the new backup system module 160 performing a read operation. In implementations of the present invention, the data from the at least one storage device 149 in the legacy module 145 can be expired in response to a backup being completed and the data of the backup being verified.

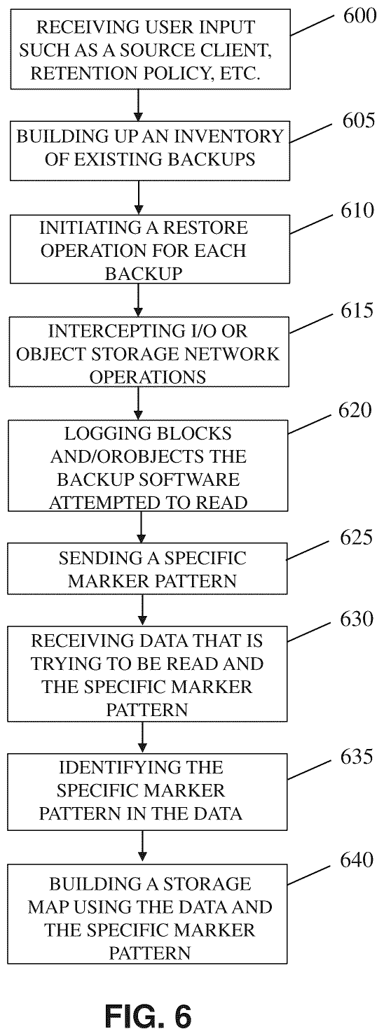

FIGS. 6-8 show flowcharts of the backup data migration system in accordance with aspects of the present invention. Steps of the method may be carried out in the backup data environment 105 of FIGS. 4 and 5.

In FIG. 6, at step 600, the system receives, at the translator module 110, user input such as a source client, retention policy, etc. At step 605, the system builds, at the translator module 110, an inventory of existing backups. At step 610, the system initiates, at the backup list module 115, a restore operation for each backup.

At step 615, the system intercepts, at the input/output (I/O) filter 130, I/O operations or object storage network operations. At step 620, the system logs, at the I/O filter 130, which blocks and/or objections the backup software 146 attempted to read and sends which blocks and/or objects were read or attempted to be read by the backup software 146 to the data stream marker module 120. At step 625, the system sends, at the data stream marker module 120, a specific marker pattern to the I/O filter module 130. In embodiments, the specific marker pattern comprises embedded patterns to mark data locations. In particular, the specific marker pattern is used to determine a plurality of offsets within individual files being restored.

At step 630, the system receives, at the I/O filter module 130, data that is trying to be read and the specific marker pattern. At step 635, the system identifies, at the restore stream module 125, the specific marker pattern in the data. At step 640, the system builds, at the storage map module 140, a storage map using the data and the specific marker pattern.

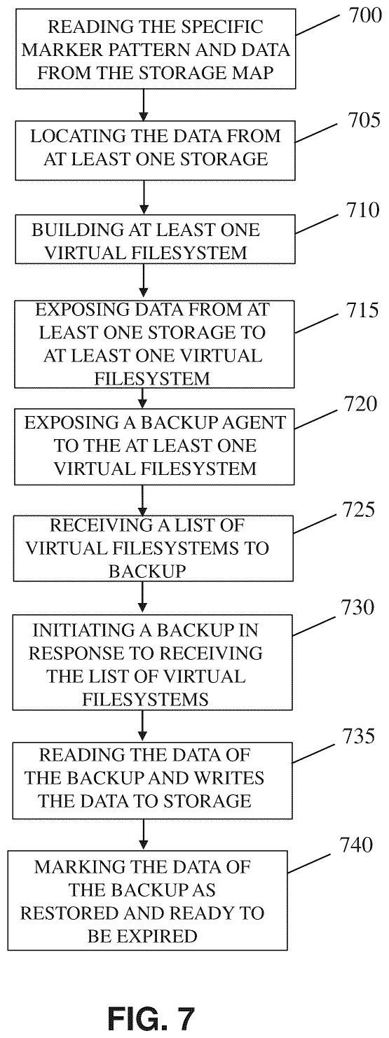

FIG. 7 shows another flowchart of the backup data migration system in accordance with aspects of the present invention. Steps of the method may be carried out in the backup data environment 105 of FIGS. 4 and 5.

At step 700, the system reads, at the storage mapping translator module 155, the data and the specific marker pattern from the storage map. At step 705, the system locates, at the storage mapping translator module 155, the data from at least one storage device 149 in the legacy module 145. At step 710, the system builds, at the storage mapping translator module 155, at least one virtual filesystem.

At step 715, the system exposes, at the virtual filesystem module 150, data from at least one storage to at least one virtual filesystem. At step 720, the system exposes, at the new backup system module 160, a backup agent 161 to the at least one virtual filesystem. At step 725, the system receives, at the new backup system module 160, a user input which includes a list of virtual filesystems to backup.

At step 730, the system initiates, at the new backup system module 160, a backup in response to receiving the list of virtual filesystems. At step 735, the system reads, at the new backup system module 160, the data of the backup and writes the data storage to the new backup system module 160. At step 740, the system marks, at the storage mapping translator module 155, the data of the backup as restored and ready to be expired.

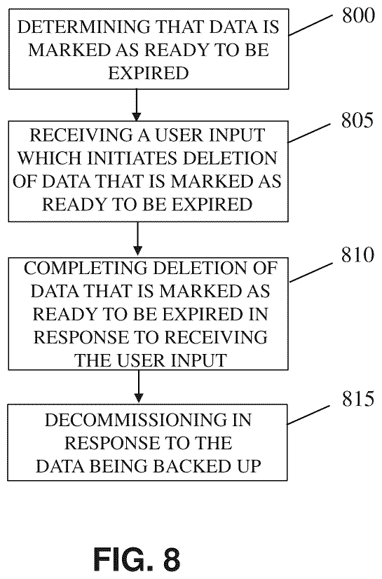

FIG. 8 shows another flowchart of the backup data migration system in accordance with aspects of the present invention. Steps of the method may be carried out in the backup data environment 105 of FIGS. 4 and 5.

At step 800, the system determines, at the storage mapping translator module 155, that data is marked as ready to be expired. At step 805, the system receives, at the storage mapping translator module 155, a user input which initiates deletion of data that is marked as ready to be expired. At step 810, the system completes, at the storage mapping translator module 155, deletion of data that is marked as ready to be expired in response to the receiving the user input. At step 815, the system decommissions, at the storage mapping translator module 155, the legacy module 145 in response to the data being backed up.

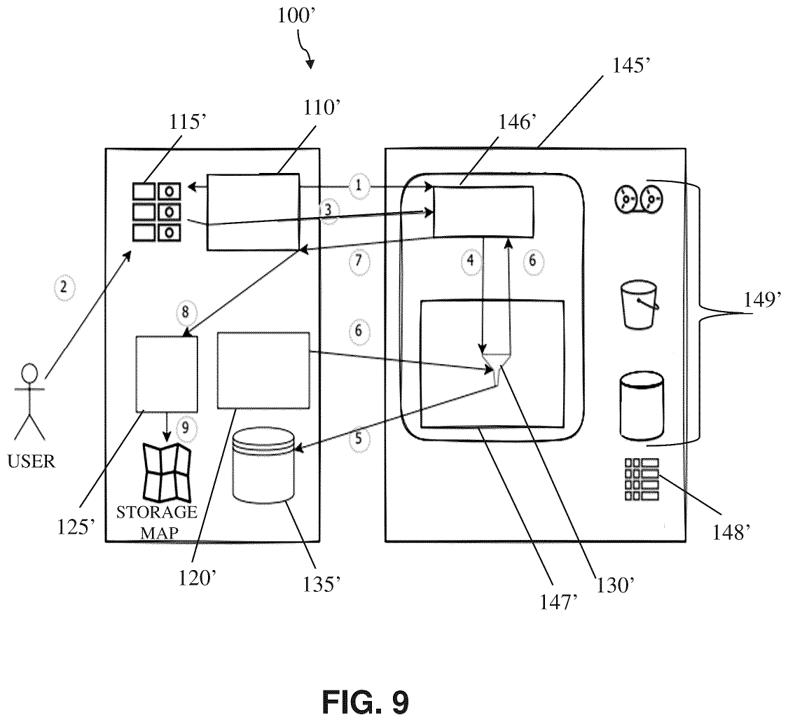

FIG. 9 shows another block diagram of the backup data migration system in accordance with aspects of the present invention. In FIG. 9, the backup data migration system 100′ is similar to the backup data migration system 100 of FIG. 4 and includes steps of a flowchart as describedbelow.

In embodiments of FIG. 9, in step 1, the translator module 110′ communicates with the backup software 146′ for building up an inventory of existing backups of the legacy module 145′. The translator module 110′ sends the inventory of existing backups to the backup list module 115′. In step 2, a user sends a user input, such as a source client, retention policy, etc., to the backup list module 115′ for pruning the inventory of existing backups. The backup list module 115′ receives the inventory of existing backups and the user input and then prunes the inventory of existing backups according to the user input. In step 3, the backup list module 115′ then initiates a restore operation for each backup in the pruned inventory of existing backups. In step 4, the I/O filter module 130′ intercepts the I/O operations or network operations in response to the backup software 146′ attempting to read data from the at least one storage disk 149′. In step 5, the I/O filter module 130′ also logs which blocks and/or objects the backup software 146′ attempted to read. The I/O filter module 130′also sends which blocks and/or objects the backup software 146′ attempted to read to the data stream marker module 120′.

In embodiments of FIG. 9, in step 6, the data stream marker module 120′ sends a specific marker pattern to the I/O filter module 130′. In embodiments, the specific marker pattern includes the data locations to determine a plurality of offsets within individual files being restored. The I/O filter module 130′ responds to requests from the backup software 146 with data which includes the specific marker pattern. In step 7, the backup software 146′ sends the data with the specific marker pattern to the translator module 110′. In step 8, the translator module 110′ sends the data with the specific marker pattern to the restore stream module 125′. The restore stream module 125′ identifies the specific marker pattern in the data based on a mapping. In step 9, the restore stream module 125′ then builds a storage map using the data with the specific marker pattern.

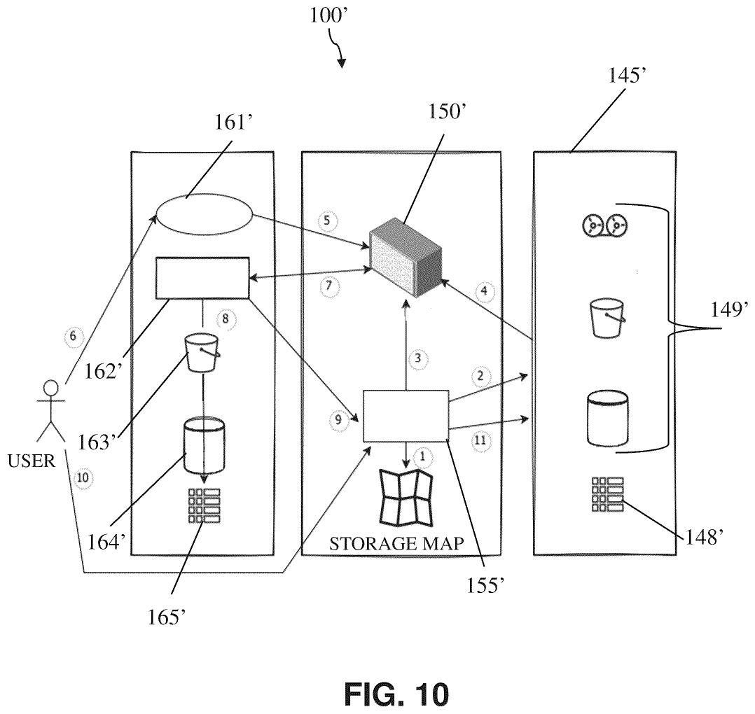

FIG. 10 shows another block diagram of the backup data migration system in accordance with aspects of the present invention. In FIG. 10, the backup data migration system 100′ is similar to the backup data migration system 100 of FIG. 5 and includes steps of a flowchart as described below.

In aspects of the present invention, in step 1, the storage mapping translator module 155′ reads the built storage map to identify where each object is located within the at least one storage device 149′. In step 2, the storage mapping translator module 155′ locates the data from the at least one storage device 149′ in the legacy module 145′ using pointers included in the built storage map. In step 3, the storage mapping translator module 155′ builds at least one virtual filesystem and sends the at least one virtual filesystem to the virtual filesystem module 150′. Accordingly, in step 4, data from at least one storage device 149′ is exposed through the at least one virtual filesystem in the virtual filesystem module 150′.

In embodiments of FIG. 10, in step 5, the backup agent 161′ is installed in a server which is exposed to the virtual filesystem module 150′. In step 6, the user sends another user input which includes a list of virtual filesystems to backup to the backup agent 161′. The backup agent 161′ initiates a backup in response to receiving the another user input which includes the list of virtual filesystems to backup. In step 7, the virtual filesystem module 150′ sends the backup of the list of virtual filesystems to the new backup software 162′. In step 8, the object storage 165′ reads the data of the backup from the new backup software 162′ and writes the data of the backup to the disk storage 164′. In step 9, the storage mapping translator module 155′ marks the data as already restored and “ready to be expired” in response to the new backup software 162′ writing the data of the backup to the disk storage 164′. In step 10, the user can send a further user input which initiates deletion of data marked as “ready to be expired” to the storage mapping translator module 155′. At step 11, the storage mapping translator module 155′ performs deletion of data marked as “ready to be expired” in response to receiving the further user input.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more thirdparties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of theinvention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
building, by a computing device, an inventory of existing backups in a legacy system;
initiating, by the computing device, a restore for the existing backups in the legacy system;
intercepting, by the computing device, a plurality of operations of the legacy system;
sending, by the computing device, data which comprises a specific marker pattern in response to intercepting the plurality of operations; and
building, by the computing device, a storage map using the data which comprises the specific marker pattern,
wherein the specific marker pattern comprises embedded patterns to mark data locations of the existing backups and which are used to determine offsets within individual files of the existing backups being restored.

2. The method of claim 1, further comprising receiving, by the computing device, a user input comprising a source client and a retention policy,
wherein the storage map further comprises an address of at least one storage device within the legacy system and details on where portions of individual objects or data blocks of the at least one storage device are within the legacy system.

3. The method of claim 2, further comprising pruning, by the computing device, the inventory of existing backups based on the received user input.

4. The method of claim 1, further comprising mimicking, by the computing device, restore requests for long term retention backups in the legacy system by utilizing a command line interface (CLI),
wherein the plurality of operations comprises a plurality of storage network operations.

5. The method of claim 1, wherein the plurality of operations comprises a plurality of input/output operations.

6. The method of claim 1, further comprising logging, by the computing device, a plurality of blocks that were attempted to be read in the plurality of operations.

7. The method of claim 6, further comprising determining, by the computing device, what address was trying to be read in the plurality of operations for at least one storage device in the legacy system.

8. The method of claim 7, wherein the data comprises the address that was trying to be read in the plurality of operations for the at least one storage device in the legacy system.

9. The method of claim 1, further comprising initiating, by the computing device, a backup of data corresponding to the built storage map.

10. The method of claim 9, further comprising writing, by the computing device, the backup of data in another storage device corresponding to the built storage map in response to initiating the backup of data.

11. The method of claim 10, further comprising marking, by the computing device, the backup of data as restored and ready to be expired.

12. The method of claim 1, wherein the computing device includes software provided as a service in a cloud environment.

13. A computer program product comprising one or more computer readable storage media having program instructions collectively stored on the one or more computer readable storage media, the program instructions executable to:
receive a storage map which comprises a specific marker pattern and information regarding data to be backed up;
build at least one virtual filesystem based on the received storage map;
expose the at least one virtual filesystem to the data to be backed up; and
initiate a backup of the data to be backed up in response to exposing the at least one virtual filesystem to the data to be backed up,
wherein the specific marker pattern comprises embedded patterns to mark data locations of the data to be backed up and which are used to determine offsets within individual files of the data to be backed up.

14. The computer program product of claim 13, wherein the program instructions are executable to write the backup of data in another storage device in response to initiating the backup of data.

15. The computer program product of claim 14, wherein the program instructions are executable to mark the backup of data as restored and ready to be expired.

16. The computer program product of claim 15, wherein the program instructions are executable to receive a user input to initiate deletion of the data to be backed up.

17. The computer program product of claim 16, wherein the program instructions are executable to delete the data to be backed up in response to receiving the user input.

18. The computer program product of claim 17, wherein the program instructions are executable to decommission a legacy system which includes the data to be backed up.

19. The computer program product of claim 13, wherein the information regarding data to be backed up comprises an address that was trying to be read for at least one storage device in a legacy system.

20. The computer program product of claim 13, wherein the storage map further comprises an address of at least one storage device within a legacy system and details on where portions of individual objects or data blocks of the at least one storage device are within the legacy system.

21. A system comprising:
a processor, a computer readable memory, one or more computer readable storage media, and program instructions collectively stored on the one or more computer readable storage media, the program instructions executable to:
build an inventory of existing backups in a legacy system;
initiate a restore for the existing backups in the legacy system;
intercept a plurality of operations of the legacy system;
send data which comprises a specific marker pattern in response to interception of the plurality of operations;
build a storage map using the data which comprises the specific marker pattern; and
provide a backup of data corresponding to the built storage map,
wherein the specific marker pattern comprises embedded patterns to mark data locations of the existing backups and which are used to determine offsets within individual files of the existing backups being restored.

22. The system of claim 21, wherein the storage map further comprises an address of at least one storage device within the legacy system and details on where portions of individual objects or data blocks of the at least one storage device within the legacy system.

23. The system of claim 21, wherein the program instructions are further executable to:
mimick restore requests for long term retention backups in the legacy system by utilizing a command line interface (CLI); and
write the backup of data in another storage device corresponding to the built storage map in response to initiating the backup of data.

24. A method, comprising:
building, by a computing device, an inventory of existing backups in a legacy system;
initiating, by the computing device, a restore for the existing backups in the legacy system;
intercepting, by the computing device, a plurality of operations of the legacy system;
sending, by the computing device, data which comprises a specific marker pattern in response to intercepting the plurality of operations;
building, by the computing device, a storage map using the data which comprises the specific marker pattern;
building, by the computing device at least one virtual filesystem based on the built storage map;
exposing, by the computing device, the at least one virtual filesystem to the data to be backed up; and
initiating, by the computing device, a backup of the data to be backed up in response to exposing the at least one virtual filesystem to the data to be backed up,
wherein the specific marker pattern comprises embedded patterns to mark data locations of the data to be backed up and which are used to determine offsets within individual files of the data to be backed up.

25. A computer program product comprising one or more computer readable storage media having program instructions collectively stored on the one or more computer readable storage media, the program instructions executable to:
build an inventory of existing backups in a legacy system;
initiate a restore for the existing backups in the legacy system;
intercept a plurality of operations of the legacy system;
send mimicked restore data which comprises a specific marker pattern in response to interception of the plurality of operations;
build a storage map using the mimicked restore data which comprises the specific marker pattern;
build at least one virtual filesystem based on the built storage map;
expose the at least one virtual filesystem to the data to be backed up; and
initiate a backup of the data to be backed up in response to exposing the at least one virtual filesystem to the data to be backed up,
wherein the specific marker pattern comprises embedded patterns to mark data locations of the existing backups and which are used to determine offsets within individual files of the existing backups being restored.
